(19) United States
(12) Patent Application Publication
(10) Pub. No.: US 2026/0232165 A1
(43) Pub. Date: Aug. 13, 2026

(54) METHOD FOR CONTROLLING DISHWASHER

(71) Applicant: LG Electronics Inc., Seoul (KR)

(72) Inventors: Yong Jin CHOI, Seoul (KR); Sang Soo LEE, Seoul (KR); IL HWAN KIM, Seoul (KR); Younhee HONG, Seoul (KR)

(73) Assignee: LG Electronics Inc., Seoul (KR)

(21) Appl. No.: 19/471,646

(22) PCT Filed: Jul. 11, 2023
(86) PCT No.: PCT/KR2023/009861

§ 371 Date: Oct. 1, 2025

(30) Foreign Application Priority Data
Apr. 6, 2023 (KR) 10-2023-0045537

(51) Int. Cl. A47L 15/00; A47L 15/42

(52) U.S. Cl. CPC A47L 15/0028; A47L 15/0034; A47L 15/0063; A47L 15/4289; A47L 2401/04; A47L 2501/04

(57) ABSTRACT

A method for controlling a dishwasher according to an embodiment may comprise the steps of: a control unit receiving a command for executing a plastic course, from among washing courses, for washing dishes made from material of plastic; the control unit receiving a command for a sub-process of the plastic course; and washing the dishes according to the plastic course and sub-process thereof received by the control unit.

### TECHNICAL FIELD

The present disclosure relates to a method for controlling a dishwasher, and more specifically, to a method for controlling a dishwasher for washing dishes made of a material easily deformable in a high temperature and high pressure state.

### BACKGROUND ART

The content described in this section merely provides background information on the present disclosure and does not constitute a prior art.

A dishwasher is a home appliance that removes foreign substances remaining on a washing target by spraying the washing water on the washing target.

The dishwasher generally includes a tub providing a washing space, a rack disposed in the tub to accommodate the washing target therein, a spray arm for spraying the washing water to a rack, a sump for storing therein washing water, and a pump for supplying the washing water stored in the sump to the spray arm.

Related prior art is disclosed in U.S. Pat. No. 11,172,805 B2.

In order to wash the dishes accommodated in the tub, high-temperature washing water may be sprayed onto the dishes to perform washing. In this case, some dishes may be deformed with high-temperature washing water or a spray pressure of the washing water. Due to light weight of the dish, the posture of the dish may be changed or a position thereof may be displaced from the original position thereof under the impact force of the spray pressure.

When the container is deformed during the washing, the container may no longer be used. In addition, when the posture of the dish may be changed or a position thereof may be displaced from the original position thereof under the impact force of the spray pressure of the washing water, the washing performance thereof may be deteriorated and noise may be generated during the washing.

For example, plastic tableware made of plastic that is not easily broken and inexpensive is widely used. Such plastic tableware generally has poor heat resistance and is also light.

Accordingly, when washing the plastic dishes by the dishwasher spraying high-temperature water at a high pressure, the plastic dishes may be deformed under the high temperature or the position thereof may be displaced and the posture thereof may be changed under the impact force applied thereto from the washing water.

For clean washing of the dishes, it is necessary to develop a method for controlling a dishwasher that may suppress the deformation, displacement, and posture change of the plastic dishes while washing the plastic dishes by spraying the high-temperature washing water thereto.

### DISCLOSURE

### Technical Purpose

A purpose of the present disclosure is to provide a method for controlling a dishwasher having a structure capable of washing dishes made of a material with poor heat resistance without deformation thereof due to heat.

In addition, a purpose of the present disclosure is to provide a method for controlling a dishwasher having a structure capable of suppressing a change in a posture or displacement of a light-material dishwasher due to the spray pressure of washing water.

In addition, a purpose of the present disclosure is to provide a method for controlling a dishwasher having a structure capable of reducing a washing time of the dishwasher according to the user's selection.

In addition, a purpose of the present disclosure is to provide a method for controlling a dishwasher having a structure in which a user may conveniently control an operation thereof.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

### Technical Solution

According to an embodiment of the method for controlling the dishwasher, a washing course may include a general course and a plastic course, and each of a maximum temperature of the washing water and a maximum spray pressure of the washing water injected from the spray arm in the plastic course may be set to be lower than each of a maximum temperature of the washing water and a maximum spray pressure of the washing water injected from the spray arm in the general course.

The dishwasher may include a temperature sensor connected to a controller and configured to sense a temperature of the washing water, and a heating device connected to the controller and configured to heat the washing water. When the temperature of the washing water measured by the temperature sensor exceeds a set value while the plastic course is in progress, the controller may be configured to stop an operation of the heating device so that the temperature of the washing water is maintained at the set value or lower.

When the plastic course is performed, the controller may be configured to control a RPM of a motor disposed in a pump to maintain the washing water spray pressure of the spray arm at a set value.

The controller may be configured to receive a command for a washing course and a command for a sub-process of a plastic course from a mobile device carried by a user. Accordingly, the user may set the command for the plastic course using the mobile device.

The user may select whether to perform the drying process using the hot air drying device when the plastic course is in progress using an application implemented in the mobile device. The user may omit the drying process, thereby reducing the time required for the washing process and the power consumption.

A method for controlling a dishwasher according to an embodiment of the present disclosure may include: receiving, by a controller, a command to perform a plastic course for washing dishes made of a plastic material, wherein a washing course includes the plastic course; receiving, by the controller, a command for a sub-process of the plastic course; and washing dishes according to the plastic course and the sub-process of the plastic course received by the controller.

The washing course may include a general course and a plastic course, wherein each of a maximum temperature of the washing water and a maximum spray pressure of the washing water sprayed from the spray arm in the plastic course is set to be lower than each of a maximum temperature of the washing water and a maximum spray pressure of the washing water sprayed from the spray arm in the general course.

The controller may be configured to receive the command for the washing course and the command for the sub-process of the plastic course from an application of a mobile device carried by a user.

The controller may be configured to be configured to receive the command for the washing course and the command for a sub-process of the plastic course from a control panel disposed on the dishwasher.

The command for the sub-process of the plastic course may include a command for selecting whether to perform the drying process of the dishes using a hot air drying device disposed in the dishwasher after the dishwasher washing process using washing water has been completed.

The application may include a section for selecting the plastic course and a section for selecting whether to perform the drying process.

The application may include a guide window for describing the plastic course, and a text for guiding selection of whether to perform the drying process may be displayed on the guide window.

The dishwasher according to an embodiment may include a plurality of racks in which dishes are accommodated, and a plurality of spray arms for spraying the washing water to the dishes, wherein each of the spray arms for spraying the washing water to each of the plurality of racks is disposed under or on top of each rack, wherein a text for indicating a plastic tableware dedicated zone in which the plastic dish is accommodated is displayed on the guide window or the rack.

The dishwasher may include a tub providing a washing space; the spray arm disposed inside the tub and configured to spray the washing water; a pump connected to the controller and configured to supply the washing water to the spray arm; a temperature sensor connected to the controller and configured to sense a temperature of the washing water; and a heating device connected to the controller and configured to heat the washing water.

When the temperature of the washing water measured by the temperature sensor exceeds a set value while the plastic course is in progress, the controller may be configured to stop the operation of the heating device.

When the plastic course is performed, the set value of the temperature of the washing water may be 55° C.

When the plastic course is performed, the controller may be configured to control the RPM of the motor disposed in the pump to maintain the washing water spray pressure of the spray arm at a set value, wherein the RPM of the motor in the plastic course may be lower than the RPM of the motor in the general course.

When the plastic course is performed, the set value of the washing water spray pressure of the spray arm may be 5 kPa.

The dishwasher may include a plurality of racks in which the dishes are received; and a plurality of spray arms for spraying the washing water to the plurality of racks, respectively, wherein at least one of the plurality of racks is designated as a plastic tableware dedicated zone, wherein when the plastic course is performed, the controller is configured to control the RPM of the motor so that the washing water spray pressure of the spray arm for spraying the washing water to the plastic tableware dedicated zone is maintained at the set value.

The dishwasher may include an upper rack disposed in an upper area of the tub and constructed to accommodate dishes therein; a lower rack disposed under the upper rack and constructed to accommodate dishes therein; an upper arm disposed between the upper rack and the lower rack and configured to spray the washing water to the upper rack; and a lower arm disposed under the lower rack and configured to spray the washing water to the lower rack, wherein when the plastic course is performed, the dish made of the plastic is accommodated in the upper rack, wherein the controller is configured to control the RPM of the motor so that the washing water spray pressure of the upper arm is maintained at the set value.

The dishwasher may be configured to perform a washing process of washing dishes by spraying the washing water to the dishes, a rinsing process of rinsing the dishes by spraying newly supplied washing water to the dishes, and a drying process of drying the dishes using a hot air drying device, wherein when the dishwasher performs the plastic course, the controller may be configured to receive a command as to whether to perform the drying process.

The washing process may include a preliminary washing process of spraying the washing water containing no detergent to the dishes and a detergent-based washing process of injecting the detergent into the washing water and spraying the washing water having the deterrent added thereto to the dishes, wherein the rinsing process may include a preliminary rinsing process of spraying the washing water containing no rinse to the dishes and a rinse-based rinsing process of injecting the rinse into the washing water and spraying the washing water having the rinse added thereto to the dishes.

The rinsing process may include a heating rinsing process. When the washing water is heated and the dishes are rinsed with the heated water, the dishes are heated, and the evaporation of the water remaining on the surface of the dishes may be promoted due to residual heat of the dishes during a subsequent drying process.

A cross-sectional area of a nozzle hole of the spray arm for spraying the washing water to the plastic tableware dedicated zone may be in a range of 7 mm² to 18 mm².

When the washing water is supplied to the spray arm for spraying the washing water to the plastic tableware dedicated zone, the RPM of the motor may be set to be lower than the RPM the motor when the washing water is supplied to the spray arm for spraying the washing water to the rack other than the plastic tableware dedicated zone.

### Technical Effect

The method for controlling the dishwasher according to the present disclosure sets the maximum temperature of washing water in the plastic course to be lower than that in the general course, thereby effectively suppressing deformation of the dishes due to the heat in washing the plastic dishes with poor heat resistance.

In addition, the method for controlling the dishwasher according to the present disclosure sets the maximum spray pressure of the washing water in the plastic course to be lower than that in the general course, thereby effectively suppressing the displacement or the change of the posture of the dishwasher when the lightweight plastic dishes are washed.

In addition, the method for controlling the dishwasher according to the present disclosure may omit the drying process according to a user's selection in the plastic course, thereby reducing the washing time and power consumption.

In addition, the method for controlling the dishwasher according to the present disclosure may provide the application implemented in the mobile device through which the user may select the plastic course and the drying process, thereby providing convenience to a user.

In addition to the above-described effects, specific effects of the present disclosure will be described together while describing the specific matters for implementing the present disclosure.

### BRIEF DESCRIPTION OF DRAWINGS

FIG. 1 is a schematic cross-sectional view of a dishwasher according to an embodiment.

FIG. 2 is a flowchart illustrating a method for controlling a dishwasher according to an embodiment.

FIG. 3 is a diagram illustrating a connection relationship between a dishwasher, a server, and a mobile device according to an embodiment.

FIGS. 4 to 7 are diagrams illustrating a method for controlling a dishwasher to perform a plastic course using an application implemented in a user's mobile device.

FIG. 8 is a block diagram for illustrating a control structure of a dishwasher according to an embodiment.

FIG. 9 is a flowchart illustrating an operation process of a dishwasher according to an embodiment.

FIG. 10 is a graph showing changes in a water temperature of washing water, current consumed by the dishwasher, a water supply amount, and power consumption during an operation of the dishwasher.

FIG. 11 is an example diagram showing a home appliance system in a home according to an embodiment.

FIG. 12 is a flowchart illustrating an operation process of a system for remotely controlling a home appliance according to an embodiment.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, etc. are used to describe various components, these components are not limited by these terms. These terms are merely used to distinguish one component from another component. Thus, unless specifically stated to the contrary, the first component may be the second component.

As used herein, unless otherwise stated, each component may be provided as one or more components.

As used herein, the singular constitutes “a” and “an” are intended to include the plural constitutes as well, unless the context clearly indicates otherwise. Further, the terms “comprise”, “comprising”, “include”, and “including” as used herein should not be construed as necessarily including all of various components or steps as described herein, and may be construed as excluding some components or some steps thereof. It will be further understood that the terms “comprise”, “comprising”, “include”, and “including” as used herein specify presence of a component or a step, but do not preclude the presence or addition of another component or step.

Throughout the present disclosure, “A and/or B” means A, B, or A and B, unless otherwise specified, and “C to D” means C inclusive to D inclusive unless otherwise specified.

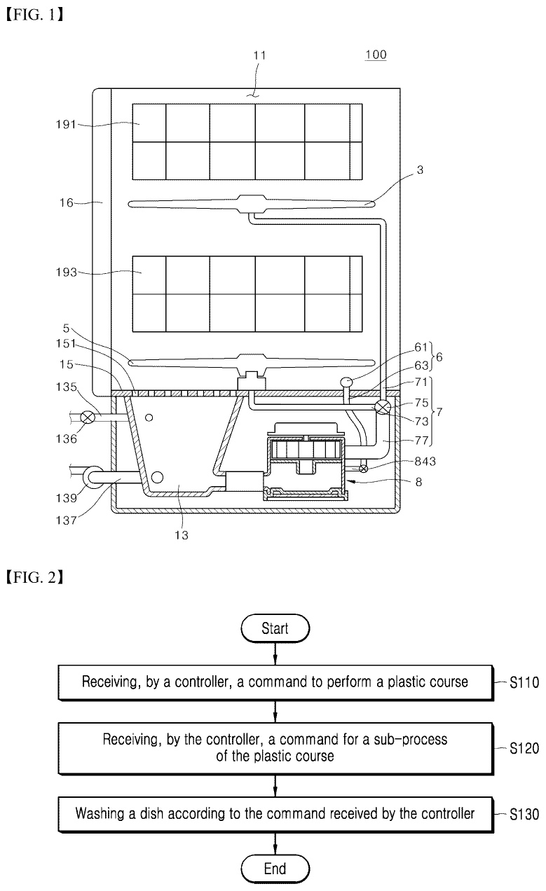

FIG. 1 is a schematic cross-sectional view of a dishwasher 100 according to an embodiment. The embodiment relates to a pump 8 capable of simultaneously performing a function of moving washing water and a function of heating washing water, and a dishwasher equipped with the pump 8.

The dishwasher 100 may include a cabinet, a tub 11 disposed inside the cabinet to provide a washing space, a spray arm 3 and 5 to spray the washing water to dishes to be washed, and the pump 8 to supply the washing water to the spray arm.

A rack in which a washing target is accommodated may be disposed inside the tub 11, and the rack may include an upper rack 191 disposed in an upper area of the tub and a lower rack 193 disposed under the upper rack 191.

Since the tub 11 is opened and closed by a door 16 disposed on one surface of the cabinet, the user may open the tub 11 with the door 16 and then withdraw the racks 191 and 193 from the tub 11.

When the rack includes the upper rack 191 and the lower rack 193, the spray arm may include an upper arm 3 for spraying the washing water to the upper rack 191 and a lower arm 5 for spraying the washing water to the lower rack 193.

The washing water sprayed from the spray arms 3 and 5 to the washing target and remaining in the tub may be collected to a sump 13.

The sump 13 refers to a means disposed under the tub 11 to store washing water therein, and may be distinguished from the tub 11 via a sump cover 15. In this case, the sump cover 15 may have a collection hole 151 defined therein communicating the inside of the tub 11 with the inside of the sump 13.

In one example, the sump 13 is connected to a water supply source through a water supply flow path 135, and the water supply flow path 135 may be opened and closed by a water supply valve 136 controlled by a controller 510.

The washing water stored in the sump 13 is discharged to the outside out of the dishwasher through a drain flow path 137 and a drain pump 139.

The washing water stored in the sump 13 is supplied to the spray arm 3 and 5 through the pump 8 and a supply flow path 7, and the supply flow path 7 may include a connection flow path 77 connected to the pump 8, a first supply flow path 71 connecting the connection flow path to the upper arm 3, and a second supply flow path 73 connecting the connection flow path to the lower arm 5.

The upper arm 3 may be rotatably coupled to the first supply flow path 71, and the lower arm 5 may be rotatably coupled to the second supply flow path 73.

In one example, although not shown, a top nozzle for spraying the washing water may be additionally disposed on top of the upper arm 3. In addition, a top rack in which dishes are accommodated may be additionally on top of the upper rack 191. The top nozzle may spray the washing water toward the dishes accommodated in the top rack.

Each of the first supply flow path 71 and the second supply flow path 73 may be branched from the connection flow path 77. In this case, a switching valve 75 for controlling opening and closing of each of the supply flow paths may be disposed at a branch point at which the connection flow path 77 divides into the first supply flow path 71 and the second supply flow path 73.

The switching valve 75 may control the flow direction of washing water. The washing water may flow simultaneously to the first supply flow path 71 and the second supply flow path 73 or selectively flow to one of the first supply flow path 71 and the second supply flow path 73 under the operation of the switching valve 75.

The pump 8 may be connected to the sump 13 and may also be connected to the supply flow path 7. Under the operation of the pump 8, the washing water may flow sequentially to the sump 13, the pump 8, the supply flow path 7, the spray arm 3 and 5, and the sump 13 to circulate inside the dishwasher 100.

In one example, in order to heat the washing water stored in the pump 8, a heating device 530 may be disposed under the pump 8.

The dishwasher 100 may wash dishes by spraying steam thereto. In order for the pump 8 to perform a function of generating the steam, the pump 8 may further include a steam outlet 843 for discharging the steam generated therein to the tub 11.

As shown in FIG. 1, the steam outlet 843 may communicate with the tub 11 through a steam supply 6, and the steam supply 6 may include a nozzle 61 fixed to the tub 11 and a supply pipe 63 connecting the nozzle 61 and the steam outlet 843 to each other.

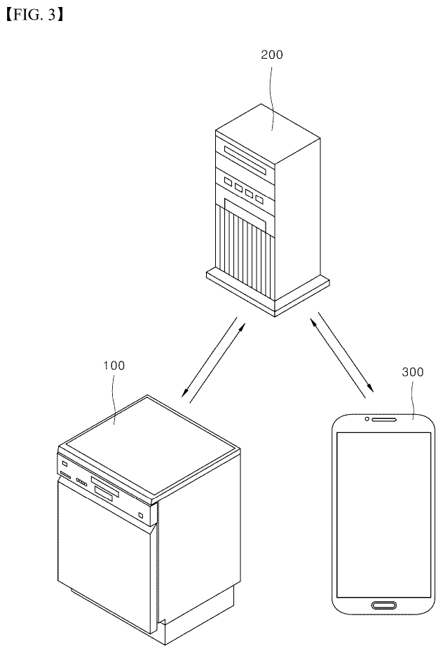

FIG. 2 is a flowchart illustrating a method for controlling the dishwasher 100 according to an embodiment. A following method for controlling the dishwasher 100 may be performed by the controller 510 disposed in the dishwasher 100.

The dishwasher 100 may perform a washing course. The washing course may include a general course and a plastic course. The general course is a washing course that is carried out in washing dishes made of a non-plastic material. The plastic course is a washing course that is carried out when washing the plastic dishes.

The plastic tableware or dish has poor heat resistance and is lighter than the tableware made of other materials such as metal and ceramic. Accordingly, when the washing of the plastic dishes is performed in the general course, the deformation thereof may occur due to the high-temperature washing water, or the light weight the position of the plastic dishes or the posture thereof may be changed under the spraying pressure of the washing water sprayed from the spray arm.

In particular, when the position where the dish is placed is deviated or the posture in which the dish is stored is changed, the washing water is not sufficiently supplied to an entirety of the dish, so that the washing efficiency may be lowered, and noise may be generated during the washing process.

Therefore, there is a need for a handling scheme that may suppress thermal deformation and displacement of the plastic dishes in washing the plastic dishes, thereby preventing damage to the plastic dishes, increasing washing efficiency thereof, and suppressing the noise.

The method for controlling the dishwasher 100 according to the embodiment relates to a washing process of the plastic dishes. In the method for controlling the dishwasher 100, first, the controller 510 may receive a command for the washing course.

The user may input a command for whether to perform the general course or the plastic course among the washing courses to the dishwasher 100. When the dishwasher 100 washes the plastic dishes, for example, dishes made of LDPE, PET, PP, SAN, and HDPE, the user may store the plastic dishes in the rack and may input a command to perform the plastic course among the washing courses to the dishwasher 100.

The dishwasher 100 may perform the general course washing in response to that the user inputs the general course washing. The dishwasher 100 may perform the plastic course washing in response to that the user inputs the plastic course washing. In addition, even when the plastic course is performed, the plastic dish and the non-plastic dish may be placed into the rack, and then the plastic dish and the non-plastic dish may be washed together with each other.

The controller 510 may receive a command to perform the plastic course for washing dishes made of the plastic material among the washing courses in S110. As the plastic course is input, the plastic course may be performed during the washing course.

The controller 510 may receive a command for a sub-process of the plastic course in S120. The command for the sub-process may include a command for whether to perform a drying process P150 using a hot air drying device. This will be described in detail below.

The dishwasher 100 may wash the dishes according to the command received by the controller 510 in S130. In this case, the dishwasher 100 may wash the dishes according to the plastic course and the sub-process of the plastic course received by the controller 510 in S130. Upon receiving the command from the user, the controller 510 may, for example, perform the plastic course including the drying process P150 or the plastic course free of the drying process P150.

In the dishwasher 100, the washing course may include the general course and the plastic course. The general course is to wash the dishes in the absence of the plastic tableware. Various sub-courses of the general course may be performed according to the user's selection.

In the plastic course, the maximum temperature of the washing water and the maximum spray pressure of the washing water injected from the spray arm may be set to be lower than those of the general course. In the washing process, the dishwasher 100 may heat the washing water and spray the heated washing water to the dishes to increase washing efficiency.

In order to suppress the deformation of the plastic dishes with poor heat resistance due to the heated washing water in the plastic course, the maximum temperature of the washing water may be set to be lower than that of the general course. The deformation of the plastic dishes may be suppressed by setting the maximum temperature of the washing water to be low in an entirety of the dish washing process.

In the plastic course, the water spray pressure of the washing water sprayed from the spray arm is set to be lower than that of the general course, so that the position of the light plastic tableware may be prevented from being displaced due to the spraying pressure of the washing water, or the posture of the plastic tableware may be prevented from being changed due to the spraying pressure of the washing water, thereby increasing the washing efficiency and suppressing the noise generation.

The user inputs a command for selecting the plastic course to the dishwasher 100, and accordingly, the controller 510 may control the operation of the dishwasher 100 so that each of the temperature and the spray pressure of the washing water in the plastic course is maintained at a set value.

On, for example, two user interfaces, the user may select the washing course, and select the sub-process of the plastic course.

One user interface may be a control panel. The control panel may be disposed, for example, on an upper portion of a front surface of the door 16 of the dishwasher 100 or on a top surface of the door 16. The user may input a necessary command by manipulating the control panel.

The controller 510 may be configured to receive a command for the washing course and a command for a sub-process of the plastic course from the control panel disposed in the dishwasher 100.

The other user interface may be the mobile device 300 carried by the user. The controller 510 may be configured to receive a command for a washing course and a command for a sub-process of a plastic course from the mobile device 300 carried by the user. The controller may be configured to receive a user's command from an application implemented in the mobile device 300.

For the user's convenience, an application for controlling the operation of the dishwasher 100 may be implemented in the mobile device 300, for example, a portable terminal such as a smartphone or a tablet PC. The user may select a plastic course and a sub-process of the plastic course through the application.

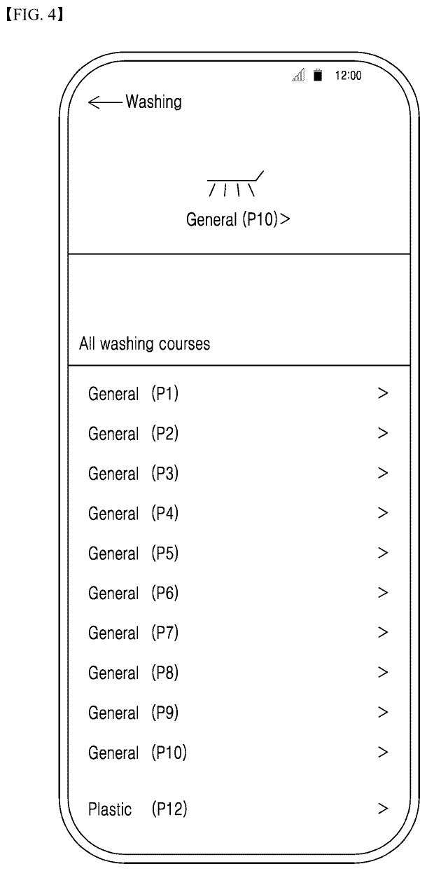

FIG. 3 is a diagram for illustrating a connection relationship between the dishwasher 100, the server 200, and the mobile device 300 according to an embodiment.

The dishwasher 100 may be communicatively connected to the server 200. A communication hub for connection with the server 200 is disposed around a place where the dishwasher 100 is disposed, and the dishwasher 100 may be connected to the communication hub to communicate with the communication hub in a wired or wireless manner. Accordingly, the dishwasher 100 and the server 200 which are far apart from each other may be connected to each other so as to communicate with each other through the communication hub.

The mobile device 300 may be connected to the server 200 to communicate with the server 200 wirelessly. The mobile device 300 may be connected to the above-described communication hub through a short-range wireless communication network such as Wi-Fi and Bluetooth and thus may be connected to the server 200 via the communication hub. Alternatively, the mobile device 300 may be connected to the server 200 via a commercial communication network service such as LTE or 5G.

Accordingly, the mobile device 300 may be connected to the server 200 regardless of the location of the mobile device 300, so that the user may conveniently control the operation of the dishwasher 100.

In one example, the above-described command for the sub-process of the plastic course may include a command for selecting whether to perform the dish drying process P150 using the hot air drying device disposed in the dishwasher 100 after the dish washing process using the washing water has been completed.

After the washing of the dishes has been completed by spraying the washing water to the dishes in the washing process of the dishwasher 100, the drying process P150 for removing water remaining on the surface of the dish may be performed. In order to dry the dishes, the dishwasher 100 may be provided with the hot air drying device that sprays heated air, that is, hot air, to the tub 11 to dry the moisture on the dishes inside the tub 11.

The plastic is generally a hydrophilic material. Therefore, it is relatively difficult to remove moisture remaining on the surface of the plastic tableware, compared to the tableware made of a material such as metal or ceramic.

Accordingly, when the plastic dishes are dried using the hot air drying device, a larger amount of time and power may be consumed compared to a case in which the dishes made of other materials are dries using the hot air drying device. Therefore, it may be advantageous to omit the drying process P150 in the plastic course in order to quickly end the operation of the dishwasher and reduce the power consumption.

The user may remove the drying process P150 and leave the door 16 in an open state such that the dishes are naturally dry or the user may manually remove the moisture from the plastic dishes. Accordingly, the drying process P150 may be performed or omitted in the plastic course according to the user's selection.

The user may select whether to perform the drying process P150 in inputting the command for the sub-process of the plastic course such that the drying process P150 may be omitted or performed. Hereinafter, an embodiment of the application implemented in the mobile device 300 based on a user's input of a selection command will be described in detail. In another example, this selection command may be made by the user through the control panel.

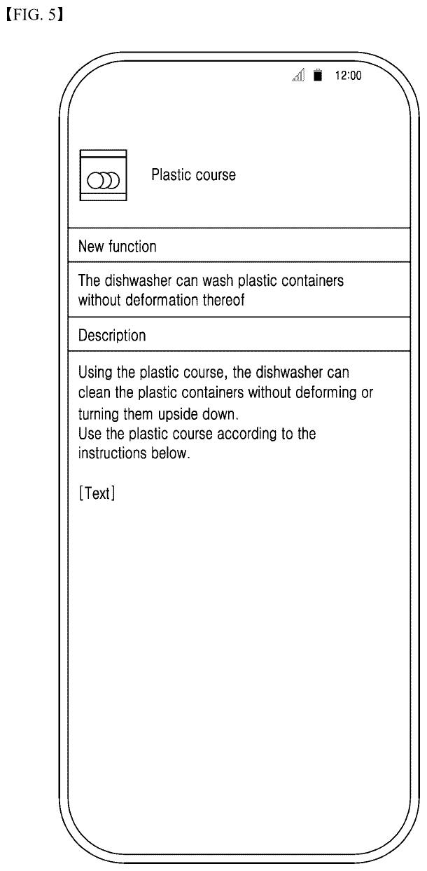

FIGS. 4 to 7 are diagrams for illustrating a method for controlling the dishwasher 100 to perform a plastic course in the application implemented in the user's mobile device 300.

The mobile device 300 may include an application for allowing the user to input the washing course of the dishwasher 100. The application may include a section for allowing the user to select the plastic course and a section for allowing the user to select whether to perform the drying process P150.

When the mobile device 300 executes the application related to the dishwasher 100, the section shown in FIG. 4 may be executed. In FIG. 4, a button for allowing the user to select the washing course may be generated.

The washing course may include the general course and the plastic course. The general course may include various sub-courses for user convenience. Therefore, in FIG. 4, for example, different types of sub-courses of the general course may include general (P1) to general (P10).

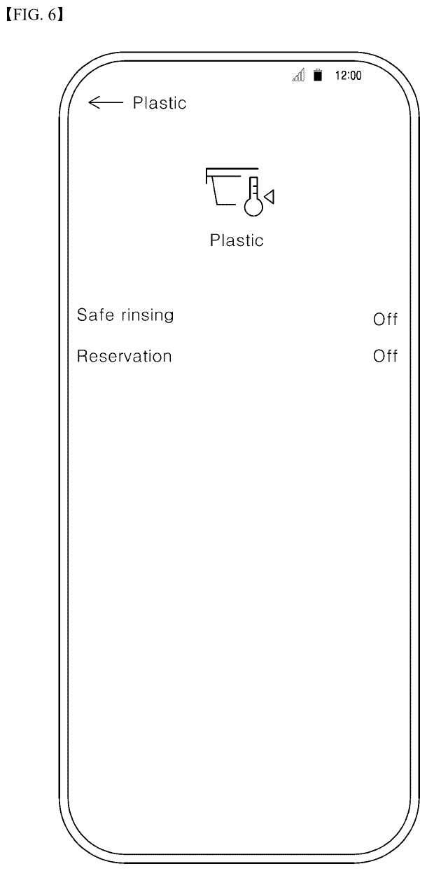

In the section shown in FIG. 4, the plastic course is indicated as plastic (P12). The user may select the plastic course by touching the plastic (P12). When the user touches the plastic (P12), the screen of the application may change to the section shown in FIG. 5.

The application may include a guide window for describing the plastic course. This may be, for example, a guide window illustrated in FIG. 5.

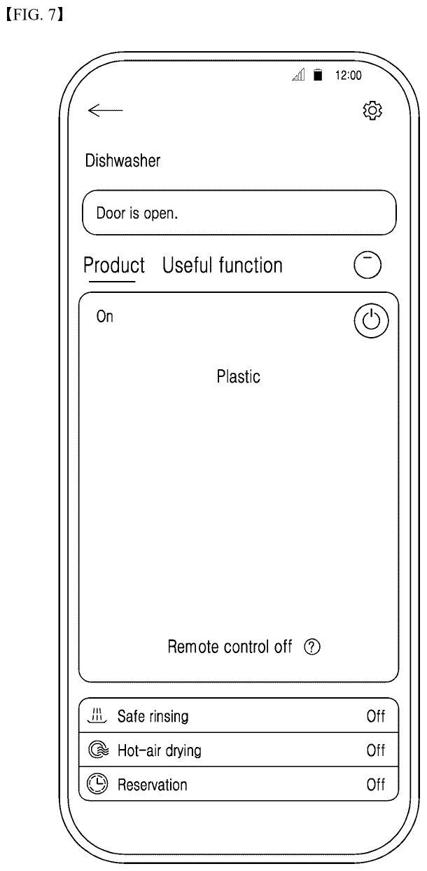

When the plastic course is selected, as shown in FIG. 5, the application may provide a guide and a description of the plastic course to the user. When the user touches the “plastic course” in the application, the screen of the application may change to the section shown in FIG. 6.

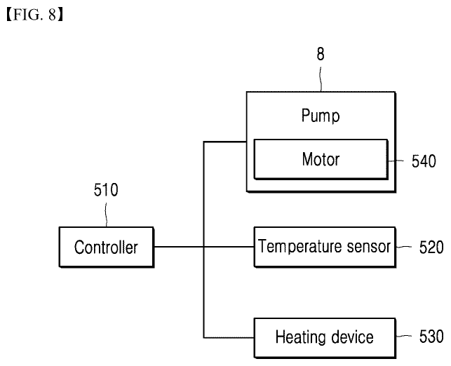

Referring to FIG. 6, the user may select detailed options for proceeding with the plastic course. Currently, the safe rinsing and reservation functions are turned off. The user may touch the application screen to change an off state related to the safe rinsing or reservation option to an on state thereof to execute the safe rinsing or reservation option. When the user touches “plastic” in the application, the screen of the application may change to the section shown in FIG. 7.

A text guiding selection of whether to perform the drying process P150 may be displayed on the guide window of the application. This is, for example, as shown in FIG. 7. As illustrated in FIG. 7, when the user selects the plastic course, the application may display a text for guiding the user to select whether to perform the drying process P150. However, in FIG. 7, this is indicated as “hot air drying”.

The user may select to turn off or turn on the “hot air drying” and input a command for whether to perform the drying process P150 to the dishwasher 100. When the above-described settings are completed, the dishwasher 100 may perform the plastic course as set by the user.

The dishwasher 100 may include a plurality of racks in which dishes are accommodated and a plurality of spray arms for spraying the washing water to the dishes. Each of the spray arms for spraying the washing water to a corresponding rack may be disposed under or on top of each of the plurality of racks.

When the plastic course is to be performed, the tableware made of the plastic may be accommodated in one set rack.

The rack may include the upper rack 191 and the lower rack 193, and the user may accommodate the plastic dishes in one of the two racks 191 and 193 and may control the dishwasher to lower the spray pressure of the washing water from the spray arm corresponding to the rack receiving therein the plastic dishes, thereby washing the plastic dishes and simultaneously reducing a manufacturing cost of the dishwasher.

For example, the upper rack 191 may be set as a place for accommodating the plastic tableware therein. The user may be more interested in washing the plastic dishes than in washing the dishware made of other materials.

Accordingly, the user is capable of placing the dishes into the upper arm 3 relatively more conveniently than into the lower rack 193. Thus, the upper rack 191 may be set as a place for accommodating the plastic tableware therein, thereby providing convenience to the user.

In this regard, it is necessary to notify the user of the rack into which the plastic tableware is accommodated. Accordingly, a text guiding a plastic dish dedicated zone into which only the plastic dishes are accommodated may be displayed on the guide window of the application.

For example, the text indicating the rack into which the plastic tableware is accommodated may be written in a description section in the guide window of the screen shown in FIG. 5. In one example, the text may be described as follows.

“To wash the plastic tableware, please store the plastic tableware in a top basket.” In the text, the top basket means the upper rack 191.

Alternatively, the text may be described as follows.

“A function of preventing the dish from being turned upside down is only applied to the top basket. Store the lightweight dish which is easily turned upside down into the top basket.”

As the above described guide text is written on the guide window of the application, the user may store the plastic tableware in a designated rack without confusion. Thus, a situation in which the dish is stored in a wrong position such that the dish is displaced or the posture thereof is changed may be effectively suppressed.

In addition, a text indicating that at least one rack among the plurality of racks is the plastic dish dedicated zone may be displayed on the at least one rack. The user may store the plastic dishes into the plastic tableware dedicated zone based on the text displayed on the rack.

For example, when the upper rack 191 is set as the plastic tableware dedicated zone, for example, a text “Plastic tableware only” may be displayed on a position of the upper rack 191 at which the text is easily noticeable to the user.

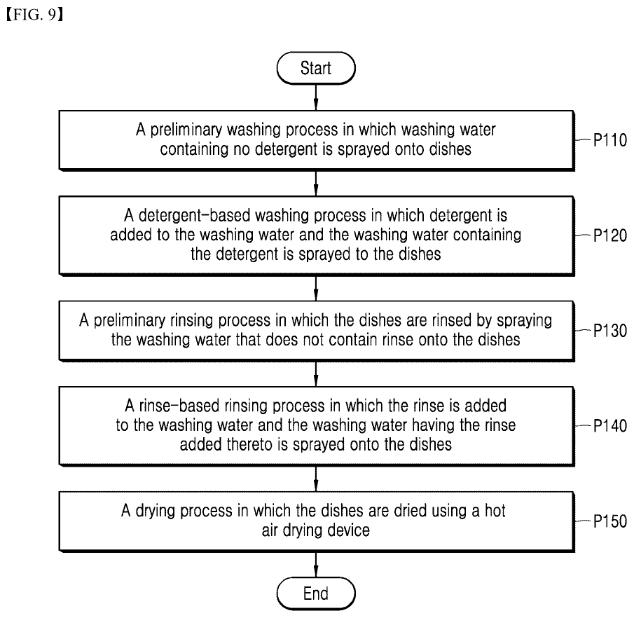

FIG. 8 is a block diagram for illustrating a control structure of the dishwasher 100 according to an embodiment. The dishwasher 100 may include the tub 11, the spray arm, the pump 8, a temperature sensor 520, and the heating device 530.

The tub 11 may provide a washing space, and the rack and the spray arm may be disposed therein. The spray arm may be disposed inside the tub 11 and may spray the washing water.

The pump 8 may be connected to the controller 510 and may supply washing water to the spray arm. The washing water may wash the dishes accommodated in the rack while circulating through the pump 8, the spray arm, and the tub 11. The pump 8 may circulate the washing water.

The temperature sensor 520 may be connected to the controller 510 and may sense the temperature of the washing water. For example, the temperature sensor 520 may be disposed in the pump 8 circulating the washing water to accurately detect the temperature of the washing water.

The heating device 530 may be connected to the controller 510 and may heat the washing water. The heating device 530 may be embodied as, for example, an electric resistance based heating device. For example, the heating device 530 may be mounted on an outer wall of the pump 8 to heat the washing water flowing through the pump 8.

The temperature sensor 520 may transmit information on the sensed temperature to the controller 510. The operation of each of the pump 8 and the heating device 530 may be controlled by the controller 510. When the plastic course is in progress, the temperature of the washing water may be controlled not to exceed a set value so that the washing water is not overheated.

For example, when the plastic course is in progress, and when the temperature of the washing water measured by the temperature sensor 520 exceeds the set value, the controller 510 may stop the operation of the heating device 530.

During the entire washing process, the temperature sensor 520 may detect the temperature of the washing water present in the pump 8 and transmit the detected temperature value to the controller 510. In the embodiment, since the heating device 530 is disposed on the wall surface of the pump 8, the temperature sensor 520 may be disposed in the pump 8. However, the temperature sensor 520 may be positioned in any one of the sump 13, the tub 11, and the circulation flow path as long as the heating device 530 may be disposed thereon.

When the temperature of the washing water exceeds the set value, the controller 510 may stop the operation of the heating device 530 to prevent the washing water from being heated. Due to this control, the temperature of the washing water may be maintained at a value below the set value throughout the washing process.

Accordingly, it may be effectively suppressed that the plastic dishware is deformed by the high-temperature washing water in the plastic course.

The set value of the temperature of the washing water controlled by the controller 510 may be determined through an experiment. When the plastic course is performed, the set value of the temperature of the washing water may be 55° C.

An upper limit of the temperature at which thermal deformation of the plastic tableware of the above-described various materials does not occur was identified as 55° C. through experiments. Accordingly, the dishwasher 100 may prevent thermal deformation of the plastic dishes by controlling the temperature of the washing water not to exceed 55° C.

The controller 510 may lower the washing water spray pressure of the spray arm so that the plastic tableware is not displaced or the posture thereof is not changed. The adjustment of the spray pressure may be implemented by controlling RPM of the motor 540 of the pump 8.

When the plastic course is in progress, the controller 510 may control the RPM of the motor 540 disposed in the pump 8 so that the washing water spray pressure of the spray arm is maintained at a set value. When the RPM of the motor 540 is lowered, the spray pressure decreases. When the RPM is increased, the spray pressure may increase.

Accordingly, the RPM of the motor 540 in the plastic course may be set to be lower than the RPM of the motor 540 in the general course. Due to the setting of the spray pressure, it may be effectively suppressed that the position or the posture of the plastic dish is changed under the spray pressure of the washing water.

A cross-sectional area of a nozzle hole of the spray arm for spraying the washing water to the plastic tableware dedicated zone may be in a range of 7 mm² to 18 mm².

The spray pressure at the spray arm may vary depending on the structure of the spray arm, the diameter and the number of nozzle holes of the spray arm from which the washing water is sprayed, and a flow rate of the sprayed washing water. Therefore, it is very difficult to adjust the spray pressure of the washing water sprayed from the nozzle hole of the spray arm by adjusting a specific structure of the spray arm.

Therefore, it is preferable to adjust the washing water spray pressure at the spray arm by adjusting the RPM of the motor 540. In this regard, the washing water spray pressure may be specified, and the RPM of the motor 540 may be specified through an experiment to reach the specified spray pressure.

As a result of conducting an experiment while changing the spray pressure of the washing water injected onto the plastic tableware having various shapes and sizes, it was identified that the maximum magnitude of the spray pressure that does not cause the change in the position or posture of the plastic tableware was 5 kPa.

5 kpa is a pressure reference value of the washing water sprayed through the nozzle hole of the spray arm. A plurality of nozzle holes of the spray arm may be disposed in one spray arm and may have different shapes, sizes, and positions. The washing water discharged through the nozzle hole may be injected in an upward direction, a lateral direction, and a downward direction of the spray arm.

The nozzle hole may be formed in the various shapes of holes such as a rectangle, a triangle, a circle, and an oval. When the hole has the rectangle shape, the hole may be an elongate hole having a width of 2.5 mm and a length of 7 mm. The width range may be in a range of 1.5 to 4 mm and the length range may be in a range of 4 to 10 mm.

The circular nozzle hole may have the diameter which may be in a range of 2 mm to 7 mm. In one example, the circular nozzle hole may have the diameter of about 3 mm. Although in the present embodiment, the experiment was performed based on the elongate hole of the width 2.5 mm and the length 7 mm, the size of the nozzle hole included in the above range may be included in the scope of the present disclosure. That is, the cross-sectional area of the nozzle hole may be in a range of 7 mm² to 18 mm². It was identified that in the present embodiment, the dishes were not turned upside down when the pressure of the washing water sprayed from the nozzles of the above shapes was 5 kpa.

Accordingly, when the plastic course is performed, the set value of the washing water spray pressure of the spray arm may be 5 kPa. In another example, a small change in the spray pressure, such as a slight decrease or increase from the 5 kPa is tolerable.

The RPM of the motor 540 at which the washing water spray pressure of the spray arm is maintained at 5 kPa may be derived through an experiment. As a result of the experiment, the RPM of the motor 540 maintaining the spray pressure of 5 kPa was in a range of 2000 to 2100 RPM.

Therefore, in the plastic course, for example, the controller 510 may maintain the washing water spray pressure of the spray arm at 5 kPa by maintaining the motor 540 RPM of the pump 8 in the range of 2000 to 2100, thereby suppressing the position change and the posture change of the plastic tableware due to the spray pressure of the washing water.

The dishwasher 100 according to the embodiment may include the plurality of racks in which dishes are accommodated, and the plurality of spray arms for spraying the washing water to the plurality of racks, respectively. At least one of the plurality of racks may be designated as the plastic tableware dedicated zone.

As described above, when the plastic course is in progress, the tableware made of plastic may be accommodated in the rack designated as the plastic tableware dedicated zone. For example, the upper rack 191 may be designated as the plastic tableware dedicated zone.

When the plastic course is in progress, the controller 510 may control the RPM of the motor 540 so that the washing water spray pressure of the spray arm for spraying the washing water to the plastic tableware dedicated zone is maintained at the set value. That is, the controller 510 may control the RPM of the motor 540 so that the washing water spray pressure of the spray arm for spraying the washing water to the rack in which the plastic tableware is accommodated is maintained at the set value.

For example, the upper arm 3 may spray the washing water to the upper rack 191, and thus the controller 510 may control the RPM of the motor 540 to, for example, 2000 to 2100 so that the washing water spray pressure of the upper arm 3 is maintained at the set value, for example, 5 kPa.

A more specific example will be described as follows. The dishwasher 100 may include the upper rack 191, the lower rack 193, the upper arm 3, and the lower arm 5. The upper rack 191 is disposed in an upper area of the tub 11, and the dishes may be accommodated therein. The lower rack 193 is positioned under the upper rack 191, and the dishes may be accommodated therein.

The upper arm 3 may be disposed between the upper rack 191 and the lower rack 193, and may spray the washing water to the upper rack 191. The lower arm 5 may be disposed under the lower rack 193 and may spray the washing water to the lower rack 193.

When the plastic course is in progress, the tableware made of plastic may be accommodated in the upper rack 191. In this case, the plastic tableware and the non-plastic tableware may be accommodated in the upper rack 191 while being arranged with each other in a mixed manner. That is, the non-plastic tableware may be accommodated in the upper rack 191 in the plastic course.

In addition, in the plastic course, the non-plastic dishes may be accommodated in the lower rack 193 and may be washed therein. When the plastic course is performed, the non-plastic dishes may also be accommodated in the upper rack 191 or the lower rack 193 and washed together with the plastic dishes. However, in the plastic course, the plastic tableware may be accommodated only in the designated rack, for example, the upper rack 191.

As described above, in the plastic course, the plastic tableware may be accommodated in the upper rack 191, and then, the controller 510 may control the RPM of the motor 540 so that the washing water spray pressure of the upper arm 3 is maintained at the set value.

In this regard, the set value of the washing water spray pressure of the upper arm 3 is 5 kPa. Thus, the controller 510 may control the operation of the motor 540 so that the RPM of the motor 540 of the pump 8 is in a range of 2000 to 2100 in order to maintain the spray pressure at 5 kPa.

During the washing process, the plurality of spray arms may selectively or simultaneously spray the washing water. For example, when the spray arm includes the upper arm 3 and the lower arm 5, only the upper arm 3 may spray the washing water, only the lower arm 5 may spray the washing water, or the upper arm 3 and the lower arm 5 may simultaneously spray the washing water, during the washing process.

When the washing water is supplied to the spray arm for spraying the washing water to the plastic tableware dedicated zone, the RPM of the motor 540 may be set to a lower RPM than that when the washing water is supplied to the spray arm for spraying the washing water to the rack other than the plastic tableware dedicated zone. For example, a case where the upper rack 191 is designated as the plastic tableware dedicated zone and the upper arm 3 sprays the washing water to the upper rack 191 and the lower arm 5 sprays the washing water to the lower rack 193 will be described.

In this regard, there may be a case 1 in which the washing water is sprayed only from the upper arm 3, a case 2 in which the washing water is sprayed only from the lower arm 5, and a case 3 in which the washing water is sprayed from both the upper arm 3 and the lower arm 5.

When the plastic course is in progress, in the case 1 and the case 3, the motor 540 may operate at a relatively lower RPM compared to that in the case 2. Accordingly, the spray pressure of the washing water injected into the plastic tableware is lowered, so that the position or posture of the plastic tableware may be effectively prevented from changing.

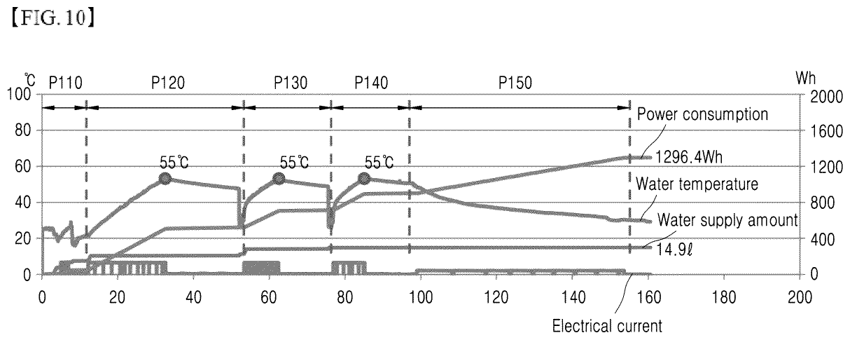

FIG. 9 is a flowchart illustrating an operation process of the dishwasher 100 according to an embodiment. FIG. 10 is a graph showing changes in the water temperature of the washing water, electrical current consumed by the dishwasher, the water supply amount, and power consumption during the operation of the dishwasher 100. In the graph of FIG. 10, a left vertical scale represents the temperature (° C.) of the washing water, a right vertical scale represents the power consumption (Wh), and a horizontal scale represents a washing progress time (minutes).

The dishwasher 100 may perform a washing process, a rinsing process, and a drying process P150. In the washing process, the dishes may be washed by spraying the washing water onto the dishes. In the washing process, the washing water may circulate through the pump 8, the spray arm, and the tub 11 to wash dishes.

The washing process may include a preliminary washing process P110 and a detergent-based washing process P120. In the preliminary washing process P110, washing water containing no detergent may be sprayed onto the dishes to wash foreign substances having a relatively large volume remaining on the dishes.

In the detergent-based washing process P120, detergent may be added to the washing water and the washing water containing the detergent may be sprayed to the dishes, such that foreign substances having a relatively small volume remaining on the dishes and not being washed well may be washed. In order to increase the washing effect, in the detergent-based washing process P120, the dishes may be washed with the heated washing water containing the detergent.

In the rinsing process, the dishes may be rinsed by spraying newly supplied washing water onto the dishes. During the washing process, the washing water is contaminated with the foreign substances remaining on the dishes. Accordingly, in the rinsing process, the washing water used in the washing process is discharged to the outside out of the dishwasher 100, and new clean washing water is introduced into the tub 11 to rinse the dishes.

The rinsing process may include a preliminary rinsing process P130 and a rinse-based rinsing process P140. In the preliminary rinsing process P130, the dishes may be rinsed by spraying the washing water that does not contain rinse onto the dishes.

In the rinse-based rinsing process P140, the rinse may be added to the washing water and the washing water having the rinse added thereto may be sprayed onto the dishes. Removing the detergent remaining on the dishes in the rinse-based rinsing process P140 using the rinse may allow the dish washing process using the washing water to be finally completed.

The rinsing process may include a heating rinsing process. When the washing water is heated and the dished are rinsed with the heated washing water, the dishes are heated, and evaporation of water remaining on the surface of the dishes may be promoted due to residual heat of the dishes during a subsequent drying process.

The heating rinse process may occur together with the rinse-based rinsing process. That is, in the rinse-based rinsing process P140, the dishes may be rinsed using heated water having the rinse added thereto.

In order to effectively rinse the dishes, in an embodiment, the dishes may be washed using the heated washing water obtained by heating the washing water in both the preliminary rinsing process P130 and the rinse-based rinsing process P140.

In the drying process P150, the dishes may be dried using the hot air drying device.

Each of the above-described processes of the dishwasher 100 may be applied to both the general course and the plastic course. However, durations of respective general courses of the different processes may be different from each other. Further, durations of respective plastic courses of the different processes may be different from each other.

For example, the duration of the plastic course of each of the processes of the dishwasher 100 is as follows.

TABLE 1

| Plastic course | Duration (minutes) |
|---|---|
| Preliminary Washing Process P110 | 8 |
| Detergent-Based Washing Process P120 | 47 |
| Preliminary Rinsing Process P130 | 25 |
| Rinse-Based rinsing process P140 | 18 |
| Drying process P150 | 60 |

In addition, in the plastic course, the drying process P150 may be performed or omitted according to a user's selection. Accordingly, when the dishwasher 100 is performed in the plastic course, the controller 510 may be configured to receive a command for whether to perform the drying process P150. Such a command may be input by the user through the mobile device 300 carried by the user or the control panel disposed on the dishwasher 100.

As shown in the above Table 1, the drying process P150 may take a considerable amount of time, for example, 60 minutes. When the drying process P150 is performed in the plastic course, a total time of the plastic course may be significantly increased. In addition, referring to FIG. 10, when the drying process P150 is performed in the plastic course, power may be continuously consumed to operate the hot air drying device.

Therefore, it may be advantageous to omit the drying process P150 in the plastic course in order to quickly end the dishwasher and reduce the power consumption. The user may remove the drying process P150 and leave the door 16 in the open state such that the dishes are naturally dried or the user manually removes the moisture from the plastic dishes. Accordingly, in the plastic course, the drying process P150 may be performed or omitted according to the user's selection.

Referring back to FIG. 10, the heating of the washing water may be performed during each of the detergent-based washing process P120, the preliminary rinsing process P130, and the rinse-based rinsing process P140. During each of the processes in the plastic course, the controller 510 may maintain the maximum temperature of the washing water at the set value, for example, 55° C. or lower to suppress deformation of the plastic tableware under the heat.

In addition, the control of the washing water spray pressure of the spray arm may be performed during each of the preliminary washing process P110, the detergent-based washing process P120, the preliminary rinsing process P130, and the rinse-based rinsing process P140. During each of the processes in the plastic course, the controller 510 may control, for example, the RPM of the motor 540 of the pump 8 so that the washing water spray pressure of the upper arm 3 is maintained at 5 kPa, thereby preventing the plastic tableware from being displaced due to the spray pressure or preventing the posture thereof from being changed due to the spray pressure.

In an embodiment, the maximum temperature of the washing water in the plastic course may be set to be lower than that in the general course, thereby effectively suppressing the deformation of the plastic dishes due to the heat when washing the plastic dishes having poor heat resistance.

In an embodiment, the maximum spray pressure of the washing water in the plastic course may be set to be lower than that in the general course, thereby preventing the plastic tableware from being displaced due to the spray pressure or preventing the posture thereof from being changed due to the spray pressure.

In an embodiment, in the plastic course, the drying process P150 may be omitted according to the user's selection, thereby shortening the washing time of the dishes and reducing the amount of power consumption.

In an embodiment, the application implemented in the mobile device 300 on which the user may select the plastic course and the drying process P150 may be provided, such that convenience may be provided to the user.

Hereinafter, a home appliance system in a home for remotely controlling a dishwasher and an operation process of the system for remotely controlling a home appliance including the dishwasher will be described. Reference numerals of the components as described below may be different from the reference numerals of the components as described above.

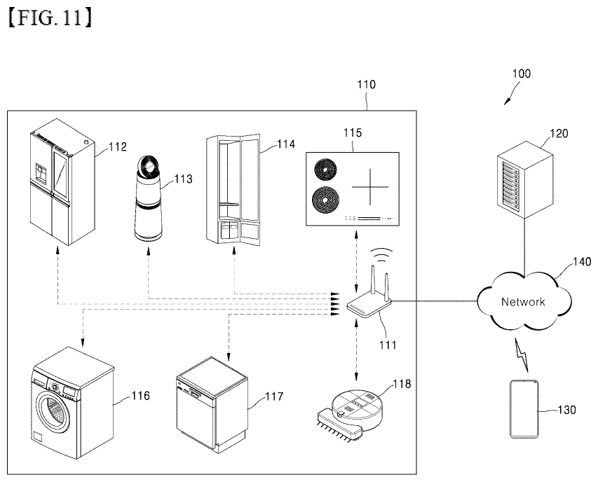

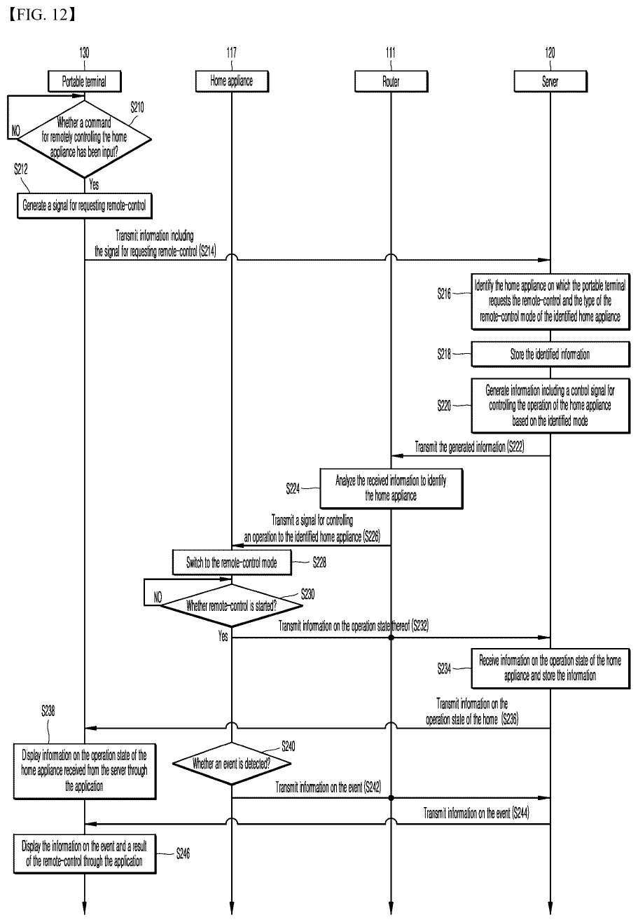

FIG. 11 is an example diagram showing a home appliance system in a home according to an embodiment.

Referring to FIG. 11, a home appliance system 100 in a home according to an embodiment may include a plurality of home appliances 110, a server 120 (e.g., a ThinQ server), and a portable terminal 130 that monitors and controls each of the plurality of home appliances 110.

A configuration of the home appliance system 100 illustrated in FIG. 11 is merely based on one embodiment, and the components of the home appliance system 100 are not limited to the embodiment as illustrated in FIG. 11, and some components may be added, changed, or deleted as necessary.

For example, the server 120, the portable terminal 130, and a router 111 in the home may transmit and receive a signal for remotely controlling the plurality of home appliances 110 through a network 140. An application (e.g., a ThinQ application) for remotely controlling the plurality of home appliances 110 is installed in the portable terminal 130.

In addition, the home appliance system 100 may further include the router 111 for relaying information transmitted and received between the plurality of home appliances 110. Each home appliance may transmit a signal related to remote-control to the server 120 through the router 111, or may receive a signal related to remote-control from the server 120 through the router 111.

The router 111 is connected to a communication line installed in a place such as the home or an office to transmit a wireless signal. The plurality of home appliances 110 are located within a range in which the home appliances 110 are capable of receiving the wireless signal from the router 111.

The router 111 receives the wireless signal transmitted from the home appliance (e.g., the dishwasher 117) and the user terminal 130 communicatively connected to the router 111 and transmits the wireless signal to an external device through the communication line, or converts a signal input from an external source through the communication line into the wireless signal and transmits the wireless signal.

Accordingly, the home appliance (e.g., the dishwasher 117) connected to the router 111 may communicate with the server 120.

When the home appliance is remotely controlled through the portable terminal 130, a signal transmitted from the portable terminal 130 may be transmitted to the home appliance through the server 120 and the router 111.

In addition, when remote-control is directly performed on the home appliance, the home appliance may transmit a signal related to remote-control to the portable terminal 130 through the router 111 and the server 120.

Alternatively, when a communication protocol (e.g., Bluetooth, Wi-Fi, or the like) is provided to the home appliance, the home appliance system 100 in the home may also perform one-to-one communication between the home appliance and the portable terminal.

According to an embodiment, the plurality of home appliances 110 may include a refrigerator 112, an air purifier 113, a clothing care apparatus 114, an induction heater 115, a washing machine 116, the dishwasher 117, and a robot cleaner 118 disposed in the home. In addition, the plurality of home appliances 110 may include various home appliances (e.g., ovens) that may be disposed and used in the home.

According to an embodiment, each home appliance of the plurality of home appliances 110 may receive a signal (or information) for remotely controlling the home appliance from the portable terminal 130. Each home appliance may operate in a remote-control mode based on this information.

As described above, in order for each home appliance of the plurality of home appliances 110 to operate in the remote-control mode, the portable terminal 130 may request the server 120 to upgrade the application, and the server 120 may transmit the updated software to the portable terminal 130 in response to the request.

For the upgrade, the portable terminal 130 may transmit information including an identifier (e.g., a phone number and a unique ID) of the portable terminal, a model name of the home appliance, a serial number of the home appliance, a software version of the home appliance, software contents, and etc. to the server 120, and the server 120 may store information on the various home appliances therein.

In addition, the server 120 may compare the information received from the portable terminal 130 with the information pre-registered in the server 120, and may select one of a general upgrade or an automatic upgrade as a software upgrade scheme for the home appliance based on the comparing result. Alternatively, the server 120 may select one of the general upgrade and the automatic upgrade based on the model name, the serial number, etc. of the home appliance.

Alternatively, the server 120 may transmit software or information required for the upgrade to the portable terminal 130 in advance in a push manner.

In order to provide the upgrade related to an application for remotely controlling the home appliance, the server 120 may store firmware of the home appliance and data (i.e., content program data) about a content program executed on the firmware in a memory (not shown)

Based on the information from the server, each home appliance of the plurality of home appliances 110 may not operate in the remote-control mode (e.g., Off Mode), may operate in a remote-control one-time available mode (e.g., Manual Mode), or may operate in a remote-control always available mode (e.g., Permanent Mode).

To this end, each home appliance of the plurality of home appliances 110 may transmit and receive signals or data to and from the server 120 in a wireless or wired manner. For example, the home appliance may transmit a signal or data to the server 120 through the router 111, or receive a signal transmitted from the portable terminal 140 through the server (e.g., the ThinQ server) 120 and the router 111. The signal or data may include a program for remote-control, a control signal, operation information, pairing information, and etc.

According to an embodiment, each home appliance of the plurality of home appliances 110 may store the signal or data received through the server 120 in a memory.

According to an embodiment, the server 120 may transmit a program (e.g., a ThinQ application) capable of remotely controlling the home appliance to at least one home appliance in the home through the router 111.

Alternatively, the server 120 may transmit the program (e.g., a ThinQ application) capable of remotely controlling the home appliance to the portable terminal 130.

According to an embodiment, the portable terminal 130 may have the program (e.g., a ThinQ application) installed therein which may be capable of remotely controlling the home appliance in the home, and thus the portable terminal 130 may remotely control at least one home appliance in the home through the program.

For example, the remote-control mode may include a mode in which the home appliance does not operate in the remote-control mode, a mode in which the home appliance is remotely controlled once, and a mode in which the home appliance is always remotely controlled.

FIG. 12 is a flowchart illustrating an operation process of a system for remotely controlling a home appliance according to an embodiment.

Hereinafter, an operation process of a system for remotely controlling a home appliance according to an embodiment will be described in detail with reference to FIG. 12.

The system according to the present disclosure may include the home appliance (e.g., the dishwasher 117), the portable terminal 130, and the server 120. Hereinafter, a case in which the home appliance is the dishwasher 117 will be described. However, the technical idea according to the present disclosure may be applied not only to the dishwasher, but also to other home appliances in the home (e.g., the refrigerator 112, the air purifier 113, the clothing care apparatus 114, the induction heater 115, the washing machine 116, the robot cleaner 118, and the oven (not shown)).

First, the portable terminal 130 may request a function for remotely controlling at least one home appliance in the home to the server 120 through the application, and receive the function (or program) for remotely controlling at least one home appliance in the home from the server 120 in response to the request.

Thereafter, the portable terminal 130 may add and install the function (or program) received from the server 120 to the application (e.g., the ThinQ application).

The portable terminal 130 may display the application in which the function of remotely controlling at least one home appliance has been installed on a display. For example, the portable terminal 130 may receive information on a current state (e.g., a remote-control mode, an operation state, functions of each home appliance, an error state, etc.) of the home appliance from the server 120 and display the information through the application in real time.

Alternatively, the portable terminal 130 and the home appliance 117 may perform one-to-one communication with each other through a short-range communication protocol (e.g., Bluetooth, Wi-Fi, etc.) without communication with the server 120.

According to an embodiment, the portable terminal 130 may identify whether a command for remotely controlling the home appliance (e.g., the dishwasher 117) has been input through the application displayed on the display in in S210.

For example, the portable terminal 130 may select a home appliance to be remotely controlled by a user through the application, and may receive a command regarding whether to allow the selected home appliance to operate in the remote-control one-time-available mode or always.

Alternatively, the portable terminal 130 may receive a command for not using the remote-control mode for preventing the selected home appliance from being remotely controlled through the application.

According to an embodiment, the portable terminal 130 may generate a signal for requesting remote-control in in S212. When a command for remotely controlling the selected home appliance (e.g., the dishwasher 117) is input to the portable terminal 130 from the user, the portable terminal 130 may generate a request signal including an identifier (e.g., a model name) of the selected home appliance (e.g., the dishwasher 117), an identifier (e.g., a telephone number) of the portable terminal 130, a type of a remote-control mode (e.g., a remote-control unavailable mode, a remote-control one-time-available mode, or a remote-control always-available mode), and a remotely-controlled function (e.g., steam, intensive washing, high-temperature sterilization, safe rinsing, hot air drying, reservation, etc.) of the selected home appliance (e.g., the dishwasher 117).

According to an embodiment, the portable terminal 130 may transmit information including the signal for requesting remote-control to the server 120 in S214. The portable terminal 130 may generate information including various information (e.g., a remote-control request time, an Internet address of the server 120) in the request signal generated in the process S212, and then transmit the information to the server 120.

According to an embodiment, the server 120 may identify the home appliance on which the portable terminal 130 requests the remote-control and the type of the remote-control mode of the identified home appliance in S216. The server 120 may analyze the request signal received from the portable terminal 130 and may identify the type (e.g., the dishwasher 117) of the home appliance which is requested to be remotely controlled, the type of the remote-control mode of this home appliance (e.g., the remote-control unavailable mode, the remote-control one-time-available mode, or the remote-control always-available mode), and the remotely-controlled function (e.g., steam, intensive washing, high-temperature sterilization, safe rinsing, hot air drying, reservation, etc.) of this home appliance (e.g., the dishwasher 117).

According to an embodiment, the server 120 may store the identified information in a memory (not shown) in S218. The server 120 may identify the home appliance (e.g., the dishwasher 117) requested to be remotely controlled and the remoted controlled function thereof, based on the identifier of the portable terminal 130 and may store the identified functions in a memory (not shown). This identification result may be used to determine a function on which a remote-control mode is frequently used by customers to develop or utilize a product in the future.

According to an embodiment, the server 120 may generate information including a control signal for controlling the operation of the home appliance based on the identified mode in S220. The server 120 may generate a signal including instructions for controlling a remote-control mode (e.g., a remote-control unavailable mode, a remote-control one-time-available mode, or a remote-control always-available mode) on the home appliance (e.g., the dishwasher 117) requested to be remotely controlled as identified in the process S216, and a remotely-controlled function (e.g., steam, intensive washing, high-temperature sterilization, safe rinsing, hot air drying, reservation, etc.) of this home appliance (e.g., the dishwasher 117).

For example, the server 120 may generate information obtained by including the identifier (e.g., a phone number) of the portable terminal 130 in the generated signal.

According to an embodiment, the server 120 may transmit the generated information to the router 111 in S222. Based on the user's request (e.g., the type of the remote-control mode of the home appliance, a function to be remotely controlled thereof), the server 120 may transmit the information for allowing the user to remotely control the home appliance (e.g., the dish washer 117) through the portable terminal 130 to the router 111 which in turn may provide the transmitted information to the home appliance (e.g., the dish washer 117).

According to an embodiment, the router 111 may analyze the received information to identify the home appliance in S224. The router 111 may identify the home appliance based on the information received from the server 120 and forward the information to the identified home appliance.

According to an embodiment, the router 111 may transmit a signal for controlling an operation to the identified home appliance in S226. Alternatively, the router 111 may analyze the information received from the server 120 and provide the analysis result to the identified home appliance or may perform a function of simply forwarding the received information to the identified home appliance.

According to an embodiment, the home appliance (e.g., the dishwasher 117) may switch to the remote-control mode in S228. The home appliance (e.g., the dishwasher 117) may switch (or set) a current operation mode (e.g., the remote-control unavailable mode) to the remote-control mode (e.g., the remote-control one-time-available mode or the remote-control always-available mode) based on the information received through the router 111.

Alternatively, the home appliance (e.g., the dishwasher 117) may also switch the current operation mode (e.g., the remote-control one-time-available mode or the remote-control always-available mode) to the remote-control unavailable mode.

According to an embodiment, the home appliance (e.g., the dishwasher 117) may identify whether remote-control is started in S230. The home appliance (e.g., the dishwasher 117) may identify whether the home appliance (e.g., the dishwasher 117) is switched to the remote-control mode (e.g., the remote-control one-time-available mode or the remote-control always-available mode) based on the received information and thus is currently operating in the switched remote-control mode.

When the home appliance (e.g., the dishwasher 117) has been switched to the remote-control mode (e.g., the remote-control one-time-available mode or the remote-control always-available mode), the home appliance (e.g., the dishwasher 117) may display information on the switched remote-control mode on the display (e.g., a first manipulation panel 320 of FIG. 3).

For example, when the home appliance (e.g., the dishwasher 117) has been switched to the remote-control one-time-available mode, the home appliance (e.g., the dishwasher 117) may output a predetermined color (e.g., green) through a light-emitting element of the first manipulation panel (320 of FIG. 3).

Alternatively, when the home appliance (e.g., the dishwasher 117) has been switched to the remote-control always-available mode, the home appliance (e.g., the dishwasher 117) may output a predetermined color (e.g., blue) through the light-emitting element of the first manipulation panel (320 of FIG. 3).

As described above, the home appliance (e.g., the dishwasher 117) may output different colors based on the different types of the remote-control modes to allow the user to recognize the type of the current remote-control mode of the home appliance (e.g., the dishwasher 117).

When the remote-control mode is the remote-control unavailable mode, the home appliance (e.g., the dishwasher 117) may turn off the light-emitting element of the first manipulation panel (320 of FIG. 3).

According to an embodiment, the home appliance (e.g., the dishwasher 117) may transmit information on the operation state thereof to the server 120 through the router 111 in S232. For example, the information may include information indicating that the remote-control of the home appliance (e.g., the dishwasher 117) is started.

As described above, the home appliance (e.g., the dishwasher 117) transmits the information on the operation state to the server 120 through the router 111, so that the user may remotely and in real time check various situations regarding the remote-control through the portable terminal 130.

According to an embodiment, the server 120 may receive information on the operation state of the home appliance (e.g., the dishwasher 117) and store the information in the memory (not shown) in S234. The server 120 may receive various information about the home appliance (e.g., the dishwasher 117) which is currently operating in the remote-control mode and store the received information in the memory (not shown).

According to an embodiment, the server 120 may transmit information on the operation state of the home appliance (e.g., the dishwasher 117) to the portable terminal 130 in S236. The server 120 may transmit, in real time, to the portable terminal 130, information on an operation state of the home appliance (e.g., the dishwasher 117) which is operating based on the remote-control mode.

According to an embodiment, the portable terminal 130 may display information on the operation state of the home appliance (e.g., the dishwasher 117) received from the server 120 through the application in S238. The portable terminal 130 may display, in real time, through the application (e.g., the ThinQ application), operation state information about a remotely-controlled function of the home appliance (e.g., the dishwasher 117) selected by the user.

According to an embodiment, the home appliance (e.g., the dishwasher 117) may identify whether an event is detected in S240. The home appliance (e.g., the dishwasher 117) may identify whether an event for deactivating the remote-control mode occurs while operating in the remote-control mode.

In response to that the event is detected, the home appliance (e.g., the dishwasher 117) may identify whether the user has selected the remote-control one-time-available mode or the remote-control always-available mode for the home appliance (e.g., the dishwasher 117) in the process S210.

Alternatively, when the signal has been received in the process S226, the home appliance (e.g., the dishwasher 117) may determine whether the user has selected the remote-control one-time-available mode or the remote-control always-available mode for the home appliance (e.g., the dishwasher 117) in the process S210.

According to an embodiment, when the remote-control mode is the remote-control one-time-available mode, the event (e.g., a first event) may include switching of the remote-control one-time-available mode selected through the display of the dishwasher 117 into the remote-control unavailable mode or the remote-control always-available mode.

In addition, when the remote-control mode is the remote-control one-time-available mode, the event (e.g., the first event) may include sensing of opening of the door (330 of FIG. 3) of the home appliance (e.g., the dishwasher 117), sensing of a key input on the display, completion of the cycle (e.g., preliminary washing, main washing, rinsing, heating rinsing, hot air drying, etc.) of the home appliance (e.g., the dishwasher 117), occurrence of an error (e.g., a failure, abnormal operation, etc.), and/or an input related to power on/off (ON/OFF) of the home appliance (e.g., the dishwasher 117).

As described above, when the occurrence of the event (e.g., the first event) is detected in the state in which the home appliance (e.g., the dishwasher 117) is set to the remote-control one-time-available mode, the home appliance (e.g., the dishwasher 117) may switch the remote-control mode to the inactive state.

In addition, according to an embodiment, when the remote-control mode is the remote-control always-available mode, the event (e.g., a second event) may include switching of the remote-control always-available mode selected through a display 780 (see FIG. 7) of the dishwasher 117 to the remote-control unavailable mode or the remote-control one-time-available mode.

In addition, when the remote-control mode is the remote-control always-available mode, the event (e.g., the second event) may include an error occurrence of the home appliance (e.g., the dishwasher 117).

As described above, when the occurrence of the event (e.g., the second event) is detected while the home appliance (e.g., the dishwasher 117) is set to the remote-control always-available mode, the home appliance (e.g., the dishwasher 117) may switch the remote-control mode to the inactive state.

According to an embodiment, the home appliance (e.g., the dishwasher 117) may transmit information on the event to the server 120 through the router 111 in S242. The home appliance (e.g., the dishwasher 117) may transmit information on the type of the event, information on the function stopped based on the detection of the event, and information indicating that the remote-control mode is switched to the inactive state based on the detection of the event to the server 120 through the router 111.

According to an embodiment, the server 120 may transmit information on the event to the portable terminal 130 in S244. The server 120 may transmit the information received from the home appliance (e.g., the dishwasher 117) to the portable terminal 130 in real time in the process S242.

For example, the server 120 may identify the identifier (e.g., a phone number) of the portable terminal 130 that has transmitted the information including the remote-control request signal in the process S214, and may transmit the information on the event received from the home appliance (e.g., the dishwasher 117) to the portable terminal 130 having the identified identifier in real time.

According to an embodiment, the portable terminal 130 may display the information on the event and a result of the remote-control through the application in S246. The portable terminal 130 may display the information about the event and the result of remote-control received from the server 120 on the application in real time, based on the detection of the event occurring in the home appliance (e.g., the dishwasher 117).

As described above, the user may remotely control the home appliance (e.g., the dishwasher 117) through the portable terminal 130 at a long distance from the dishwasher 117.

In addition, the user may select whether to operate the dishwasher 117 in the remote-control one-time-available mode or the remote-control always-available mode through an input on the display (e.g., the first manipulation panel 320) of the dishwasher 117.

Although the present disclosure has been described above with reference to the drawings of the present disclosure, the present disclosure is not limited to the embodiments and drawings disclosed in the present disclosure. It is obvious that various modifications may be made thereto by a person skilled in the art within the scope of the technical idea of the present disclosure. In addition, even though the effects according to the configuration of the present disclosure are not explicitly described while illustrating the embodiment of the present disclosure, it is obvious that the predictable effect therefrom should also be recognized.

1. A method for controlling a dishwasher, the method comprising:
receiving, by a controller, a command to perform a plastic course for washing a dish made of a plastic material, wherein a washing course includes the plastic course;
receiving, by the controller, a command for a sub-process of the plastic course; and
washing the dish according to the plastic course and the sub-process of the plastic course received by the controller,
wherein the washing course includes a general course and the plastic course,
wherein each of a maximum temperature of washing water and a maximum spray pressure at which a spray arm sprays the washing water in the plastic course is set to be lower than each of a maximum temperature of the washing water and a maximum spray pressure at which the spray arm sprays the washing water in the general course.

2. The method for controlling the dishwasher of claim 1, wherein the controller is configured to receive the command for the washing course and the command for the sub-process of the plastic course from an application of a mobile device carried by a user.

3. The method for controlling the dishwasher of claim 1, wherein the controller is configured to receive the command for the washing course and the command for the sub-process of the plastic course from a control panel disposed on the dishwasher.

4. The method for controlling the dishwasher of claim 2, wherein the command for the sub-process of the plastic course includes a command for selecting whether to perform a drying process of the dish using a hot air drying device disposed in the dishwasher after a dish washing process using the washing water has been finished.

5. The method for controlling the dishwasher of claim 4, wherein the application includes a section for selecting the plastic course and a section for selecting whether to perform the drying process.

6. The method for controlling the dishwasher of claim 5, wherein the application includes a guide window for describing the plastic course,
wherein a text guiding selection of whether to perform the drying process is displayed on the guide window.

7. The method for controlling the dishwasher of claim 6, wherein the dishwasher includes a plurality of racks in which dishes are accommodated, and a plurality of spray arms for spraying the washing water to the dishes,
wherein each of the spray arms for spraying the washing water to each of the plurality of racks is disposed under or on top of each rack,
wherein a text for indicating a plastic tableware dedicated zone in which the plastic dish is accommodated is displayed on the guide window or the rack.

8. The method for controlling the dishwasher of claim 1, wherein the dishwasher includes:
a tub providing a washing space;
the spray arm disposed inside the tub and configured to spray the washing water;
a pump connected to the controller and configured to supply the washing water to the spray arm;
a temperature sensor connected to the controller and configured to sense a temperature of the washing water; and
a heating device connected to the controller and configured to heat the washing water.

9. The method for controlling the dishwasher of claim 8, wherein in response to that the temperature of the washing water measured by the temperature sensor exceeds a set value while the plastic course is performed, the controller is configured to stop an operation of the heating device.

10. The method for controlling the dishwasher of claim 9, wherein when the plastic course is performed, the set value of the temperature of the washing water is 55° C.

11. The method for controlling the dishwasher of claim 8, wherein when the plastic course is performed, the controller is configured to control a RPM of a motor disposed in the pump to maintain a washing water spray pressure of the spray arm at a set value,
wherein the RPM of the motor in the plastic course is lower than the RPM of the motor in the general course.

12. The method for controlling the dishwasher of claim 11, wherein when the plastic course is performed, the set value of the washing water spray pressure of the spray arm is 5 kPa.

13. The method for controlling the dishwasher of claim 11, wherein the dishwasher includes:
a plurality of racks in which the dishes are received; and
a plurality of spray arms for spraying the washing water to the plurality of racks, respectively,
wherein at least one of the plurality of racks is designated as a plastic tableware dedicated zone,
wherein when the plastic course is performed, the controller is configured to control the RPM of the motor so that the washing water spray pressure of the spray arm for spraying the washing water to the plastic tableware dedicated zone is maintained at the set value.

14. The method for controlling the dishwasher of claim 11, wherein the dishwasher includes:
an upper rack disposed in an upper area of the tub and constructed to accommodate dishes therein;
a lower rack disposed under the upper rack and constructed to accommodate dishes therein;
an upper arm disposed between the upper rack and the lower rack and configured to spray the washing water to the upper rack; and
a lower arm disposed under the lower rack and configured to spray the washing water to the lower rack,
wherein when the plastic course is performed, the dish made of the plastic is accommodated in the upper rack,
wherein the controller is configured to control the RPM of the motor so that the washing water spray pressure of the upper arm is maintained at the set value.

15. The method for controlling the dishwasher of claim 1, wherein the dishwasher is configured to perform:
a washing process of washing the dishes by spraying the washing water to the dishes;
a rinsing process of rinsing the dishes by spraying newly supplied washing water to the dishes; and
a drying process of drying the dishes using a hot air drying device,
wherein when the dishwasher performs the plastic course, the controller is configured to receive a command for whether to perform the drying process.
